(19) United States
(12) Patent Application Publication
(10) Pub. No.: US 2019/0236662 A1
(43) Pub. Date: Aug. 1, 2019

(54) SERVER, IMAGE FORMING SYSTEM AND BILLING CONTROL METHOD FOR MANAGING BILLING OF USERS USING IMAGE FORMING APPARATUSES

(71) Applicant: KYOCERA Document Solutions Inc., Osaka (JP)

(72) Inventors: Zhenyu SUN, Osaka (JP); Masafumi SATO, Osaka (JP); Keiji TSUDA, Osaka (JP); Tatsuya HIWATARI, Osaka (JP)

(73) Assignee: KYOCERA Document Solutions Inc., Osaka (JP)

(21) Appl. No.: 16/264,235

(22) Filed: Jan. 31, 2019

(30) Foreign Application Priority Data
Jan. 31, 2018 (JP) 2018-014622

(51) Int. Cl. G06Q 30/04; H04L 29/06; G06F 3/12

(52) U.S. Cl. CPC G06Q 30/04; H04L 63/08; G06F 3/1288; G06F 3/1238; G06F 3/1222

(57) ABSTRACT

Provided is an image forming apparatus capable of flexible billing. The server manages billing of users that use image forming apparatuses. An authentication-acquiring unit acquires authentication information of users from image forming apparatuses. An authenticating unit authenticates users according to authentication acquired by the authentication-acquiring unit. A billing unit performs billing in which user billing information, which is billing information in units of the users authenticated by the authenticating unit, is applied to apparatus billing information, which is billing information in units of image forming apparatuses. A billing-control-transmitting unit transmits billing control information for controlling functions of the image forming apparatuses in correspondence with billing by the billing unit.

### INCORPORATION BY REFERENCE

This application is based on and claims the benefit of priority from Japanese Patent Application No. 2018-014622 filed on Jan. 31, 2018, the contents of which are hereby incorporated by reference.

### BACKGROUND

The present disclosure relates to a server, an image forming system, and a billing control method, and in particular, to a server, an image forming system, and a billing control method for managing billing of users who use image forming apparatuses.

Conventionally, there are image forming apparatuses such as a multifunctional peripheral (MFP) and the like capable of printing documents and images.

There is also a system that manages billing of the image forming apparatus.

In a typical technique, there is a technique aimed at promoting proper use of an image forming apparatus by a user and suitably managing billing for use of the image forming apparatus. In this typical technique, information such as a printer ID, a cartridge manufacturer ID, use start date, use end date, the number of printed sheets per user, and the like are read from a storage element of a toner cartridge, and when a cartridge manufacturer ID is a manufacturer ID that is eligible for a discount, the discount is calculated in the billing. Then, based on the number of printed sheets per user, the discount amount is apportioned for each user range, and the calculated discount amount is registered in the billing management database.

### SUMMARY

The server according to the present disclosure is a server that manages billing of users that use image forming apparatuses. The server includes an authentication-acquiring unit, an authenticating unit, a billing unit and a billing-control-transmitting unit. The authentication-acquiring unit acquires authentication information of the users from the image forming apparatuses. The authenticating unit authenticates the users according to the authentication information acquired by the authentication-acquiring unit. The billing unit performs billing in which user billing information, which is billing information in units of the users authenticated by the authenticating unit and/or units of groups to which the users belong, is applied to apparatus billing information, which is billing information in units of the image forming apparatuses. The billing-control-transmitting unit, in correspondence with billing by the billing unit, transmits billing control information for performing control of functions of the image forming apparatuses.

The image forming system according to the present disclosure is an image forming system that includes image forming apparatuses and a server that manages billing of users that use the image forming apparatuses. The image forming apparatus includes an authentication-transmitting unit and a function-control unit. The authentication-transmitting unit transmits authentication information of the users to the server. The function-control unit controls the functions of the image forming apparatus itself according to billing control information that is transmitted from the server in correspondence with the authentication information of the users transmitted by the authentication-transmitting unit, and is for performing control of functions corresponding to billing. The server includes an authentication-acquiring unit, an authenticating unit, a billing unit and a billing-control-transmitting unit. The authentication-acquiring unit acquires the authentication information of the users from the image forming apparatuses. The authenticating unit authenticates the users according to the authentication information acquired by the authentication-acquiring unit. The billing unit performs billing in which user billing information, which is billing information in units of the users authenticated by the authenticating unit and/or units of groups to which the users belong, is applied to apparatus billing information, which is billing information in units of image forming apparatuses. The billing-control-transmitting unit, in correspondence with billing by the billing unit, transmits billing control information.

The billing control method according to the present disclosure is a billing control method of image forming apparatuses that is executed by a server that manages billing of users that use the image forming apparatuses. The server acquires authentication information of the users from the image forming apparatuses. The server authenticates the users according to the acquired authentication information. The server performs billing in which user billing information, which is billing information in units of the authenticated users, is applied to apparatus billing information, which is billing information in units of the image forming apparatuses. The server, in correspondence with the performed billing, transmits billing control information for controlling functions of the image forming apparatuses.

### BRIEF DESCRIPTION OF THE DRAWINGS

FIG. 1 is a system configuration diagram of an image forming system of an embodiment according to the present disclosure.

FIG. 2 is a block diagram showing the system configuration of the server illustrated in FIG. 1.

FIG. 3 is a block diagram illustrating a functional configuration of the image forming system of an embodiment according to the present disclosure.

FIG. 4 is a flowchart of the billing management process of an embodiment according to the present disclosure.

FIG. 5A is a conceptual diagram illustrating an example of apparatus billing information of an embodiment according to the present disclosure.

FIG. 5B is a conceptual diagram illustrating an example of apparatus billing information of an embodiment according to the present disclosure.

FIG. 6A is a conceptual diagram illustrating an example of user billing information of an embodiment according to the present disclosure.

FIG. 6B is a conceptual diagram illustrating an example of user billing information of an embodiment according to the present disclosure.

### DETAILED DESCRIPTION

### Embodiments

### [System Configuration of Image Forming System X]

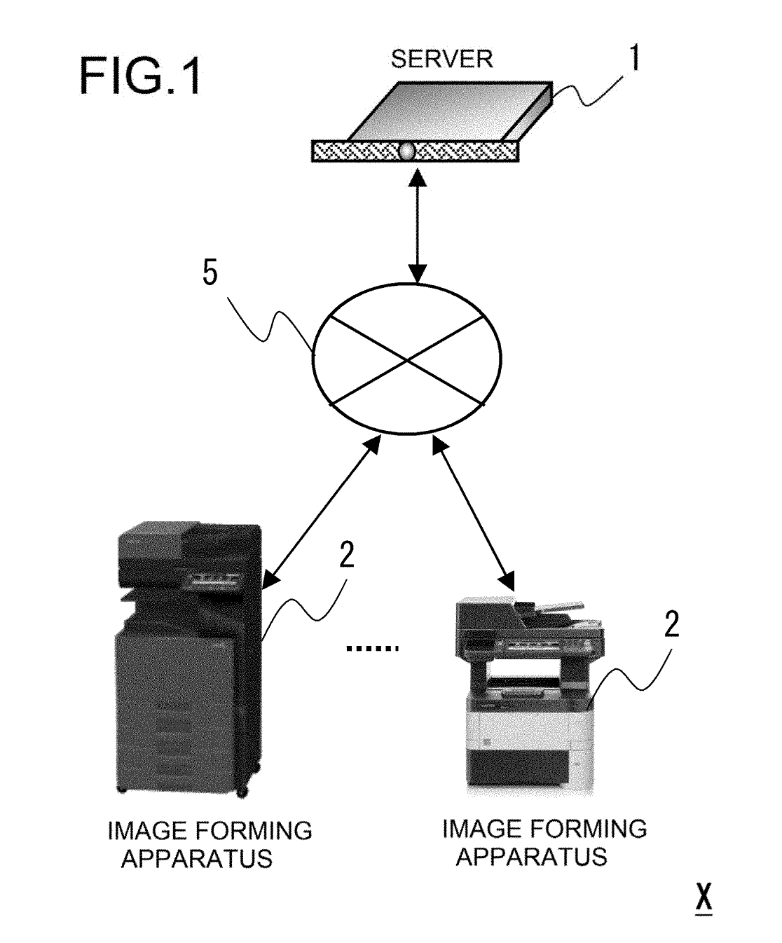

First, system configuration of an image forming system X of an embodiment according to the present disclosure will be described with reference to FIG. 1.

The image forming system X is configured by connecting a server 1 that performs billing management and a plurality of image forming apparatuses 2 installed in a customer environment via a network 5.

The server 1 is an information processing apparatus such as a PC (Personal Computer), a general-purpose machine, or the like. The server 1 manages billing of users that use each image forming apparatus 2, and performs maintenance and service correspondence. The server 1 may be a server on a so-called “cloud”. Therefore, the server 1 may provide a dedicated management screen.

In addition, the server 1 may execute image processing, OCR (Optical Character Recognition) processing, classification processing, transmission processing to an e-mail or shared folder (document box, storage folder), DMS (Document Management System) for business or office, and the like.

The image forming apparatus 2 is a document apparatus such as an MFP, a network scanner, a document scanner, a network FAX, a printer with a scanner function, a single function printer, or the like. In addition, the image forming apparatus 2 may be capable of executing an application for maintenance management.

Moreover, the image forming apparatus 2 may have various functions such as printing, copying (copy), electronic documentation by scanning, network scanning, facsimile transmission/reception, network facsimile transmission/reception, a document box for storing electronic documents, and the like. Furthermore, for each function, settings such as black-and-white, single color, full color, and the like may be possible.

In addition, in the case of an MFP, a printer or the like having a printing function, the image forming apparatus 2 includes a photosensitive drum, an exposing unit, a developing unit, a transferring unit, a fixing unit, and the like. As a result, the image forming apparatus 2 is capable of recording and printing a toner image on recording paper by executing an image forming process including charging, exposing, developing, transferring and fixing.

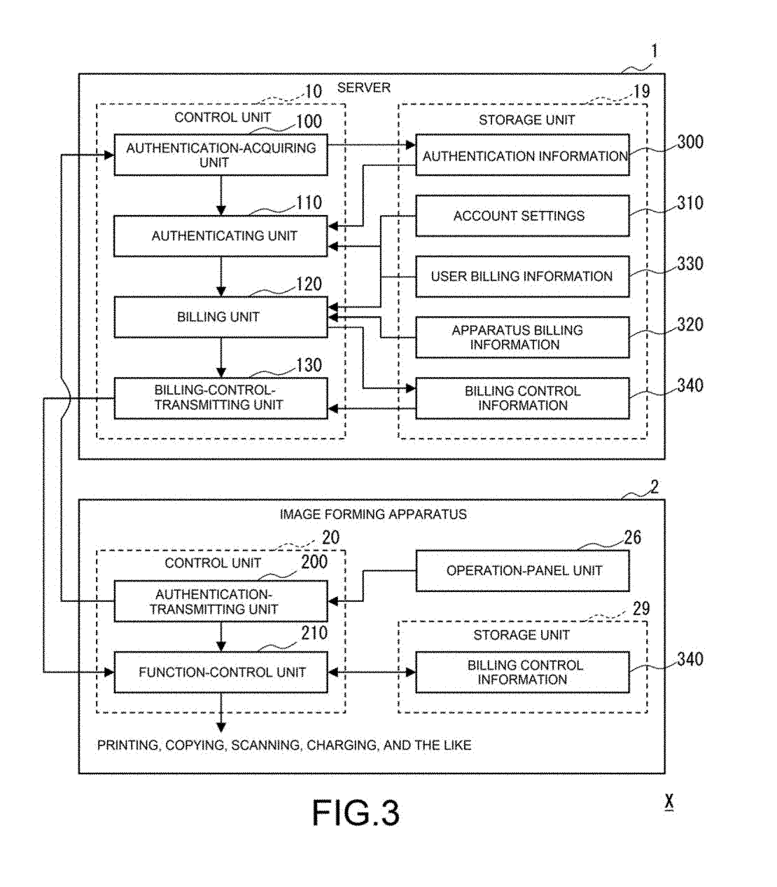

Moreover, the image forming apparatus 2 includes an operation panel unit 26 (FIG. 3) for user authentication. Furthermore, the image forming apparatus 2 may be connected to a card reader for reading an ID card, a biometric authentication device, and the like. In addition, the image forming apparatus 2 may be connected to an device or the like (hereinafter, referred to as a billing device or the like) for billing a card by a coin vendor, a reader for various electronic money or credit card, NFC (Near Field Communication) or the like.

The network 5 is a network such as an intranet such as a LAN (Local Area Network), a WAN (Wide Area Network) or the like such as the Internet, a mobile phone network, or the like.

The server 1 and each image forming apparatus 2 may be connected to the network 5 via a router, a gateway, or the like. In addition, the network 5 may constitute a VPN (Virtual Private Network).

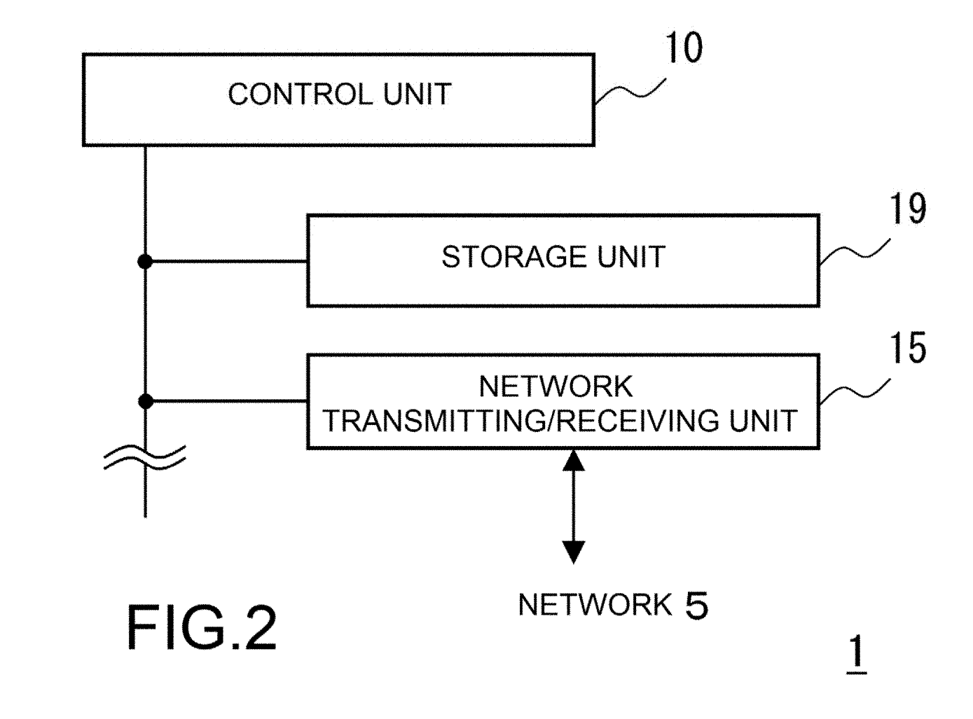

Next, the configuration of the server 1 will be described with reference to FIG. 2.

The server 1 includes a control unit 10, a network transmitting/receiving unit 15, and a storage unit 19.

The control unit 10 is an information-processing unit such as a GPP (General Purpose Processor), a CPU (Central Processing Unit), an MPU (Micro Processing Unit), a DSP (Digital Signal Processor), a GPU (Graphics Processing Unit), an ASIC (Application Specific Integrated Circuit, an application specific processor) or the like.

The control unit 10 reads a control program stored in a ROM, a SSD, or an HDD of the storage unit 19, develops the control program in a RAM, and executes the control program, thereby operating as functional units described later.

The network transmitting/receiving unit 15 is a network-connecting unit including a LAN board, a wireless transceiver, or the like for connecting to the network 5.

The storage unit 19 is a storage unit using a non-transitory recording medium. The storage unit 19 may include a RAM (Random Access Memory) or the like as a main storage unit. In addition, the storage unit 19 may include a flash memory such as a ROM (Read Only Memory), an eMMC (embedded Multi Media Card), a SSD (Solid State Drive), or the like, and/or a HDD (Hard Disk Drive) or the like as an auxiliary storage unit. In this case, a control program for performing operation control of the server 1 may be stored in the auxiliary storage section of the storage section 19.

Incidentally, the control unit 10 may be internally equipped with a RAM, a ROM, a flash memory, or the like.

### [Control Configuration of Image Forming System X]

Here, a control configuration of the image forming system X will be described with reference to FIG. 2.

The control unit 10 of the server 1 includes an authentication-acquiring unit 100, an authenticating unit 110, a billing unit 120, and a billing-control-transmitting unit 130.

The storage unit 19 of the server 1 stores authentication information 300, the account settings 310, the apparatus billing information 320, the user billing information 330, and the billing control information 340.

The control unit 20 of the image forming apparatus 2 includes an authentication-transmitting unit 200 and a function-control unit 210.

The storage unit 29 of the image forming apparatus 2 stores the billing control information 340.

In addition, in the present embodiment, the image forming apparatus 2 is connected to an operation-panel unit 26 for a user to perform authentication.

The authentication-acquiring unit 100 acquires user authentication information 300 from the image forming apparatus 2 and stores it in the storage unit 19.

The authenticating unit 110 authenticates a user based on authentication information 300 acquired by the authentication-acquiring unit 100. The authenticating unit 110 performs authentication by referencing the authentication information 300 and the account settings 310.

The billing unit 120 performs billing by applying user billing information 330, which is billing information in units of users authenticated by the authenticating unit 110 and/or in units of groups to which users belong, to apparatus billing information 320, which is billing information in units of image forming apparatuses 2.

In addition, the billing unit 120 performs billing for each function of the image forming apparatus 2. At this time, the billing unit 120 may apply different prices for black-and-white, single color, or full color printing or copying. In addition, in full color printing or copying, the billing unit 120 may further apply different prices depending on the coverage, which is the color ratio of the original.

Moreover the billing unit 120 may perform billing corresponding to the attributes and/or groups of a user.

The billing-control-transmitting unit 130 transmits billing control information 340 for controlling the function of the image forming apparatus 2 in accordance to billing by the billing unit 120.

The authentication-transmitting unit 200 acquires user authentication information 300 from the operation-panel unit 26 or the like. Then, the authentication-transmitting unit 200 transmits acquired user authentication information 300 to the server 1.

The function-control unit 210 controls the functions of its own image forming apparatus 2 based on the billing-control information 340 transmitted from the server 1 corresponding to the user authentication information 300 transmitted by the authentication-transmitting unit 200. For example, the function-control unit 210 allows the user to use various functions of the image forming apparatus 2 at a price corresponding to the billing control information 340.

The authentication information 300 is information related to user authentication. The authentication information 300 may be a user ID (identification) and password, information on an ID card, biometric authentication information, or the like. This biometric authentication information may be an image of a user's face, iris, fingerprint, vein, or the like, voice data such as a user's voice or the like.

The account settings 310 form a database in which the user ID, password, and the like are set. In addition, the account settings 310 include information such as information and the like about user attributes and groups to which the user belongs, for each user. As the user attributes, for example, whether or not the user belongs to an organization that operates an image forming apparatus 2, the position within the organization, authority within the organization, and the like may be set. Moreover, as the position in the organization, for example, a position such as whether or not the user is a student, faculty member, manager or the like may be set. Incidentally, the account settings 310 can be set by an administrator or the like of the server 1.

The apparatus billing information 320 is billing information in units of image forming apparatuses 2. In other words, different billing information is set for each image forming apparatus 2 in the apparatus billing information 320.

In addition, the apparatus billing information 320 may include price information for each function. The apparatus billing information 320 may include different price information for black-and-white, single color or full color printing or copying, for example, as this price information for each function. Of these, “black-and-white” may be set as printing by using only black (K) toner, “single color” may be set as printing by using black (K) toner and one of cyan (C), magenta (M) and yellow (Y) toner, and “full color” may be set as printing by using all toners. In addition, in full color printing or copying, the apparatus billing information 320 may further include information of different prices depending on the coverage. For example, this coverage may be set to ranges such that when the ratio of full color in a document is 80% or more, the coverage is “High”, when the ratio is 20 to 50%, the coverage is “Medium”, and when the ratio is less than 20%, the coverage is “Low”, or the like.

The user billing information 330 is billing information in user units. The user billing information 330, for example, may include billing information corresponding to an attribute included in the account settings 310 of a user. In addition, the user billing information 330 may also include billing information in group units. This group may be such that a plurality of groups including groups to which the user belongs are set. Moreover, regarding the attributes of a user and the groups to which a user belongs, an exclusive price may be set, or the price may be set such that a cheap or high price is set from among a plurality of prices.

In addition, the user billing information 330 may also include price information of each function of an image forming apparatus 2. Moreover, in the case of full color printing or copying, the user billing information 330 may further include different price information depending on the coverage. This coverage may be set as different ranges from those of the apparatus billing information 320, and the coverage may be set as different ranges for each user or group.

The billing control information 340 is information for performing control of functions corresponding to the billing of an image forming apparatus 2. The billing control information 340, for example, may include permission information as to whether or not a function instructed by an authenticated user is usable. In addition, the billing control information 340 may also include information as to whether each function can be used, such as whether color printing is possible, transmission by scanning is possible, or the like.

Here, the control unit 10 of the server 1 functions as the authentication-acquiring unit 100, the authentication unit 110, the billing unit 120, and the billing-control-transmitting unit 130 by executing the control program stored in the storage unit 19.

Here, the control unit 20 of the image forming apparatus 2 functions as the authentication-transmitting unit 200 and the function-control unit 210 by executing the control program stored in the storage unit 29.

Moreover, each unit of the server 1 and the image forming apparatus 2 described above is a hardware resource for executing the billing control method of this embodiment.

Incidentally, a part or an arbitrary combination of the above-described functional configurations may be configured as hardware such as an IC, programmable logic, FPGA (Field-Programmable Gate Array), and the like.

### [Billing Management Process by Image Forming System X]

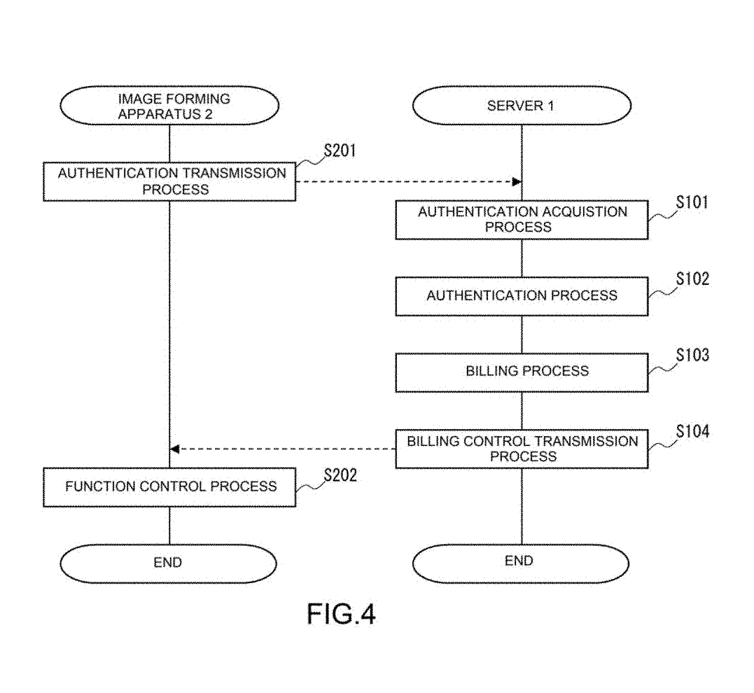

Next, the billing management process by the image forming system X of an embodiment according to the present disclosure will be described with reference to FIG. 4 to FIG. 6B.

In the billing management process of the present embodiment, first, authentication information 300 of a user is transmitted from the image forming apparatus 2 to the server 1. The server 1 acquires the authentication information 300 from the image forming apparatus 2 and authenticates the user. Then, billing is performed according to the user billing information 330 in units of authenticated users and/or units of groups and the apparatus billing information 320 in units of the image forming apparatuses 2. After that, billing control information 340 is transmitted corresponding to the billing by the billing unit 120. The image forming apparatus 2 acquires the billing control information 340 transmitted from the server 1, and controls the billing according to the price.

In the billing management process of the present embodiment, the control unit 10 mainly executes the program stored in the storage unit 19 by using the hardware resources in cooperation with each unit.

Hereinafter, the details of the billing management process of this embodiment will be described step by step with reference to the flowchart of FIG. 4.

### (Step S201)

First, the authentication-transmitting unit 200 of the image forming apparatus 2 performs an authentication transmission process.

When a user uses an image forming apparatus 2, the authentication-transmitting unit 200 performs a display prompting the user to perform authentication on a display panel of an operation-panel unit 26 or the like, and requires input of authentication information 300.

The authentication-transmitting unit 200 prompts the user to input the authentication information 300 by entering a user ID and password by an input unit of the operation-panel unit 26, by reading an ID card by a card reader, by a biometric authentication apparatus or the like.

The authentication-transmitting unit 200 transmits the inputted user authentication information 300 to the server 1.

### (Step S101)

Here, the authentication-acquiring unit 100 of the server 1 performs an authentication acquisition process.

The authentication-acquiring unit 100 acquires the user authentication information 300 from the image forming apparatus 2 via the network 5 and stores the information in the storage unit 19.

### (Step S102)

Next, the authenticating unit 110 performs an authentication process.

The authenticating unit 110 authenticates a user according authentication information 300 acquired by the authentication-acquiring unit 100. The authenticating unit 110 performs user authentication by reading the authentication information 300 from the storage unit 19 and referencing the account settings 310.

The authenticating unit 110 performs the following processing when the user authentication is successful, and terminates the billing management process in other cases.

### (Step S103)

Next, the billing unit 120 performs a billing process.

When authentication is successful, the billing unit 120 performs a setting so as to perform billing in which user billing information 330 is applied to apparatus billing information 320.

First, an example of billing corresponding to this apparatus billing information 320 will be described.

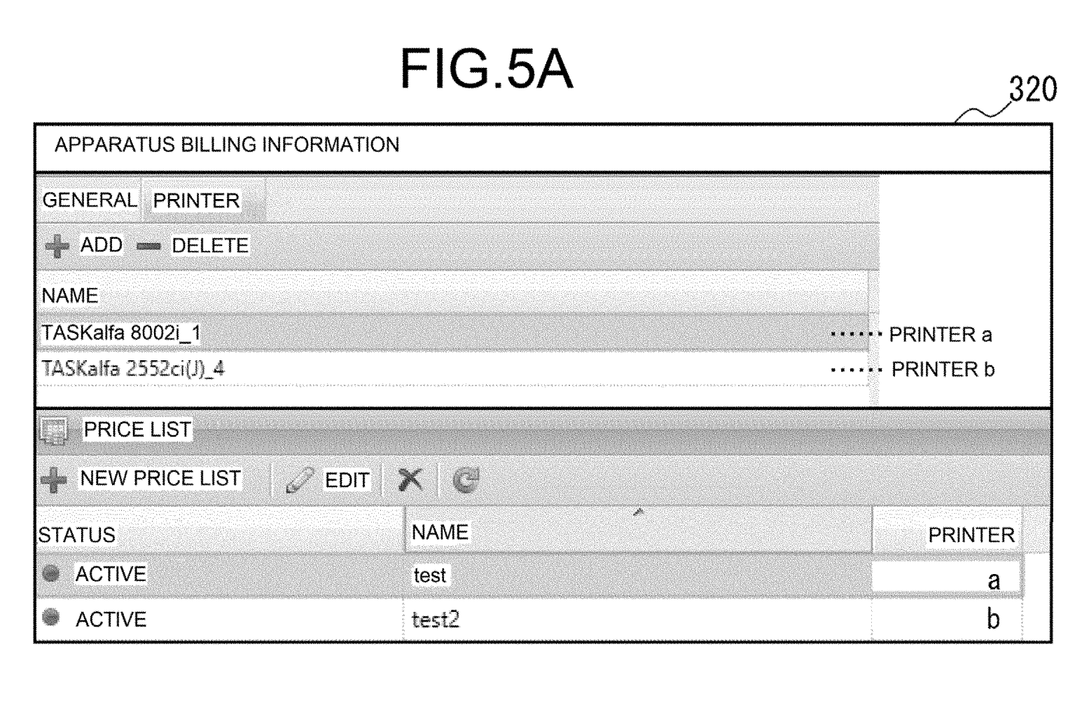

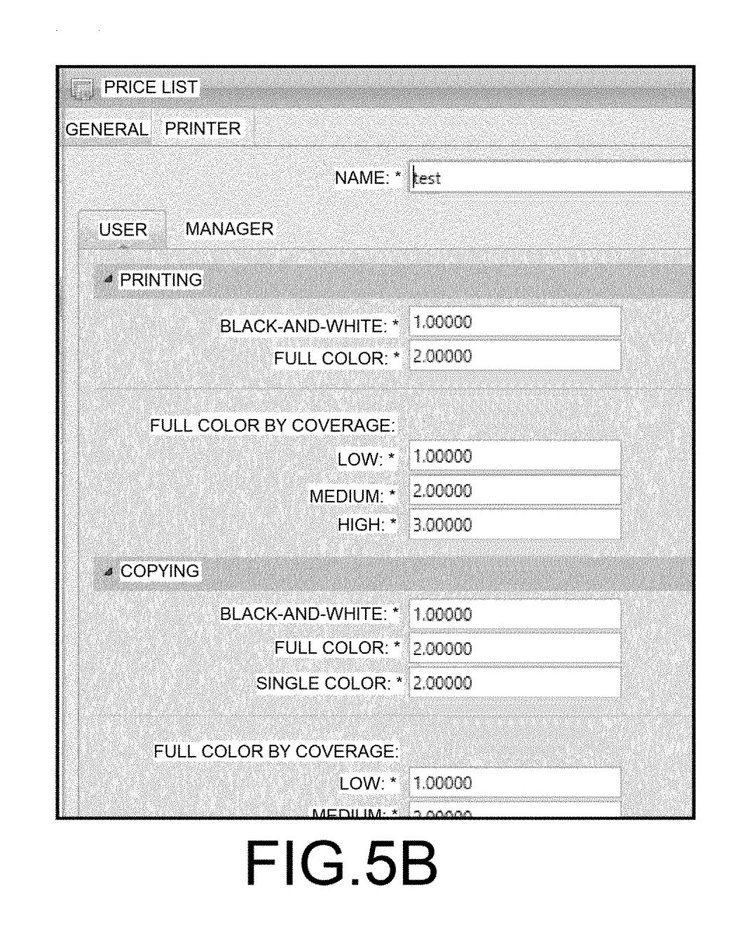

According to the example in FIG. 5A, the billing unit 120 reads and applies price lists “test” and “test 2” from the apparatus billing information 320 for each of the image forming apparatuses 2, “printer a” and “printer b”. In this example, the user performs authentication of “printer a”, and the billing unit 120 applies billing corresponding to “test”.

In this way, it is possible to bill each individual image forming apparatus 2 at different prices. Which price list to apply to each of the image forming apparatuses 2 may be set by a manager or the like of the operation of the server 1. Moreover, the price list itself may be set by a manager or the like of the operation of the server 1.

In addition, according to an example illustrating setting details of the price list “test” in FIG. 5B, the billing unit 120 respectively applies different prices to each of the items of functions such as printing, copying, scanning, and the like. As illustrated in FIG. 5B, the billing unit 120 applies different prices for black-and-white, single color, or full color as user billing information 330 for each function. Moreover the billing unit 120 further applies different prices according to the coverage. In the example in FIG. 5B, the billing unit 120 applies prices in the ranges of “high”, “medium” and “low” for printing or copying, respectively.

In addition, in the present embodiment, the billing unit 120 performs billing in which user billing information 330 corresponding to an authenticated user or groups a user belongs to is applied to the apparatus billing information 320.

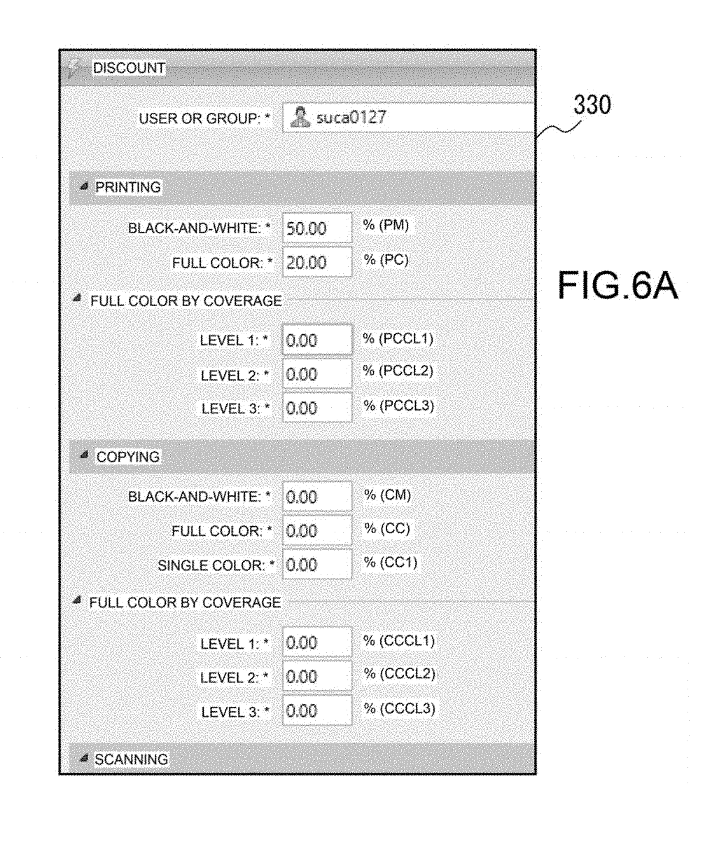

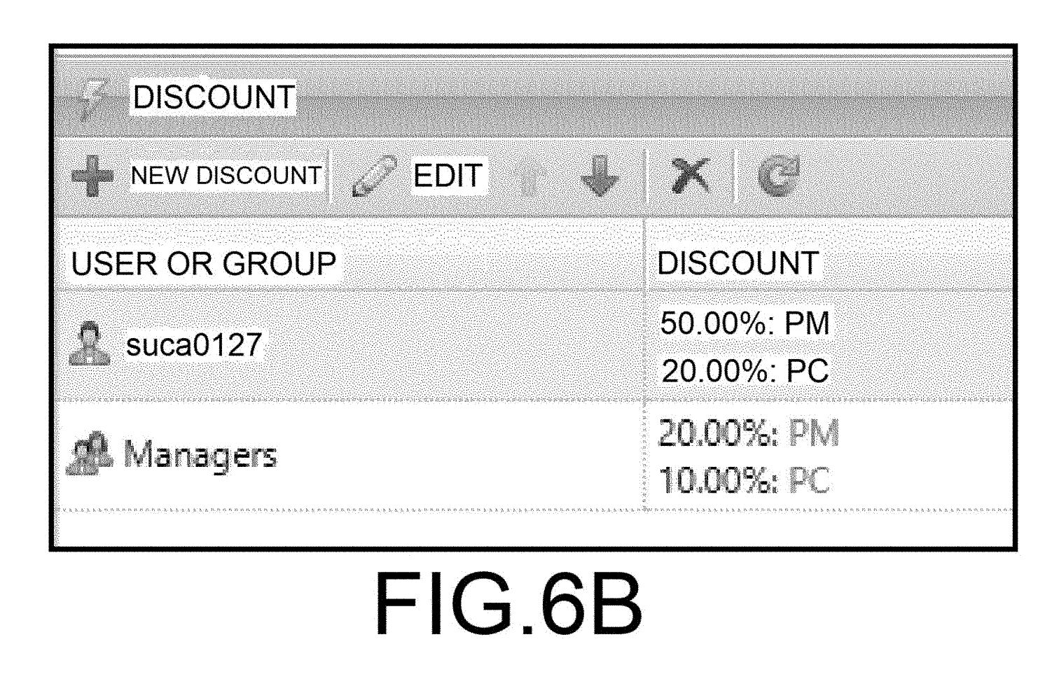

According to the example in FIG. 6A, the billing unit 120 applies a discount rate corresponding to the authenticated user or group to the price in the read price list. In this example, for the user “suca 0127”, a 50% discount is set for black-and-white printing (PM) and a 20% discount is set for full color printing (PC). Furthermore, in the case of full color coverage, discount rates in the ranges “level 1”, “level 2”, “level 3” different from the apparatus billing information 320 are set.

FIG. 6B is an example of a list illustrating a list of discount rates provided in units of users or groups in the user billing information 330. Here, it is illustrated that for the user “suca 0127” there is a 50% discount for black-and-white printing (PM) and a 20% discount for full color printing (PC) as described above. Moreover, in the group “Managers”, it is indicated that there is a 20% discount for black-and-white printing (PM) and a 10% discount for full color printing (PC).

As described above, different prices can be set in user and/or group units. Therefore, for example, at a school, different prices can be set for students, teachers and visitors, even when the same image forming apparatus 2 is used.

### (Step S104)

Next, the billing-control-transmitting unit 130 performs a billing control transmission process.

The billing-control-transmitting unit 130 creates billing control information 340 that allows the user to use the image forming apparatus at a set price and discount rate corresponding to the billing by the billing unit 120.

Then, the billing-control-transmitting unit 130 transmits the created billing control information 340.

### (Step S202)

Here, the function-control unit 210 of the image forming apparatus 2 performs a function control process.

The function-control unit 210 acquires the billing control information 340 transmitted from the server 1 and stores it in the storage unit 29. Then, the function-control unit 210 controls the billing based on the billing control information 340.

More specifically, a user, from the operation-panel unit 26, can execute each function such as printing, copying (copy), scanning, network scanning, facsimile transmission/reception, network facsimile transmission/reception, document box, and the like according to the prices and permission set by the billing control information 340. The control unit 20 of the image forming apparatus 2 controls each unit corresponding to these functions.

In addition, at this time, the function-control unit 210 may control external apparatuses that perform billing, charging or the like of a card by a billing apparatus or the like.

Thus, the billing management process of an embodiment according to the present disclosure ends.

With the configuration described above, the following effects can be obtained.

With the above-described typical technique, flexible billing cannot be performed for each image forming apparatus.

On the other hand, the image forming system X of an embodiment according to the present disclosure is an image forming system including image forming apparatuses 2 and a server 1 for managing billing of users that use the image forming apparatuses 2. The image forming apparatus 2 includes: an authentication-transmitting unit 200 that transmits user authentication information 300 to the server 1; and a function-control unit 210 that controls functions of the image forming apparatus 2 itself according to billing control information 340 that is transmitted from the server 1 in accordance with the user authentication information 300 transmitted by the authentication-transmitting unit 200, and is for performing control of functions according to the billing. The server 1 includes: an authentication-acquiring unit 100 for acquiring user authentication information 300 from the image forming apparatus 2; an authenticating unit 110 for authenticating a user based on the authentication information 300 acquired by the authentication-acquiring unit 100; a billing unit 120 that performs billing in which user billing information 330, which is billing information in units of users authenticated by the authenticating unit 110 and/or units of groups to which the users belong, is applied to apparatus billing information 320, which is billing information in units of image forming apparatuses 2; and a billing-control-transmitting unit 130 that, in correspondence with billing by the billing unit 120, transmits billing control information 340.

With this kind of configuration, it is possible to perform flexible billing management in units of apparatuses and units of user attributes. Therefore, for example, while setting different prices in units of image forming apparatuses 2, it is possible to further apply prices in units of individual users or groups. As a result, while setting different prices according to the grade and installation location of the image forming apparatus 2, it becomes possible to further set prices by distinguishing between users and groups that are designated to be able to use the apparatus at a lower price, and users and groups that can be designated to use the apparatus at a higher price, within an organization.

In addition, a feature of the server 1 of an embodiment according to the present disclosure is that the billing unit 120 performs billing for each function of the image forming apparatus 2.

With this kind of configuration, in addition to units of individual image forming apparatuses 2, it is possible to set different prices according to the functions of the image forming apparatus 2. For example, flexible billing can be applied in which the price of copying in a library is set at a high price, and the price of copying in other locations is set to a normal price.

Moreover, a feature of the server 1 of an embodiment according to the present disclosure is that the billing unit 120 applies different prices for black-and-white, single color, or full color printing or copying, and for full color printing or copying, further applies different prices according to coverage, which is the color ratio of the document.

With this kind of configuration, as specific functions, it is possible to set prices according to the details of specific functions such as printing or copying and color type. As a result, for example, in the case of an image forming apparatus 2 for which the unit price of color printing is high, flexible operation is possible in which, for example, single color printing can be set to be cheaper than full color printing, or the like.

Furthermore, a feature of the server 1 of an embodiment according to the present disclosure is that the billing unit 120 performs billing corresponding to attributes and/or groups of a user.

With this kind of configuration, it is possible to perform discount settings for each of the billing items according to each user and group. In other words, for example, it is possible to set different prices for students, teachers, managers, visitors from the outside, and the like, and flexible billing operation is possible.

### Other Embodiment

In this embodiment according to the present disclosure, it is described that the discount rate for each item is set in the user billing information 330. However, a specific price may also be set in the user billing information 330. Moreover, the discount rates may be set in the apparatus billing information 320.

With this kind of configuration, it is possible to perform flexible billing operation.

Furthermore, in addition to the price, it may be possible to set whether or not a function can be used for each function in the apparatus billing information 320 and the user billing information 330. Moreover, this kind of setting may be achieved by setting an impossible price such as “999999 euro/page”.

With this kind of configuration, it is possible to easily set or change functions that are not to be used in apparatus units, user units, or group units.

In the above-described typical technique, it is only possible to perform a uniform discount for all image forming apparatuses, and flexible billing management cannot be performed.

With a technique according to the present disclosure, billing is performed by applying user billing information in user and/or group units to apparatus billing information in image forming apparatus units, and controlling the functions of the image forming apparatus. As a result, it is possible to provide a server capable of performing flexible billing management in apparatus units and user attribute units.

In addition, the technique according to the present disclosure can also be applied to information processing apparatuses other than an image forming apparatus. In other words, configuration is also possible that uses a server or the like to which a network scanner, or scanner is separately connected by USB, or the like.

Moreover, it is needless to say that the configuration and operation of the above-described embodiment are examples and can be appropriately modified and executed within a range that does not depart from the gist of the present disclosure.

What is claimed is:

1. A server that manages billing of users that use image forming apparatuses; comprising:
an authentication-acquiring unit that acquires authentication information of the users from the image forming apparatuses;
an authenticating unit that authenticates the users according to the authentication information acquired by the authentication-acquiring unit;
a billing unit that performs billing in which user billing information, which is billing information in units of the users authenticated by the authenticating unit and/or units of groups to which the users belong, is applied to apparatus billing information, which is billing information in units of the image forming apparatuses; and
a billing-control-transmitting unit that, in correspondence with billing by the billing unit, transmits billing control information for performing control of functions of the image forming apparatuses.

2. The server according to claim 1, wherein
the billing unit
performs billing for each function of the image forming apparatus.

3. The server according to claim 2, wherein
the billing unit
applies different prices for black-and-white, single color, or full color printing or copying; and
for full color printing or copying, further applies different prices according to coverage, which is the color ratio of the document.

4. The server according to claim 1, wherein
the billing unit
performs billing corresponding to attributes and/or groups of the user.

5. An image forming system comprising image forming apparatuses and a server that manages billing of users that use the image forming apparatuses, wherein
the image forming apparatus comprises:
an authentication-transmitting unit that transmits authentication information of the user to the server; and
a function-control unit that controls the functions of the image forming apparatus itself according to billing control information that is transmitted from the server in correspondence with the authentication information of the user transmitted by the authentication-transmitting unit, and that is for performing control of functions corresponding to billing; and
the server comprises:
an authentication-acquiring unit that acquires the authentication information of the users from the image forming apparatuses;
an authenticating unit that authenticates the users according to the authentication information acquired by the authentication-acquiring unit;
a billing unit that performs billing in which user billing information, which is billing information in units of the users authenticated by the authenticating unit and/or units of groups to which the users belong, is applied to apparatus billing information, which is billing information in units of image forming apparatuses; and
a billing-control-transmitting unit that, in correspondence with billing by the billing unit, transmits the billing control information.

6. A billing control method of image forming apparatuses that is executed by a server that manages billing of users that use the image forming apparatuses; wherein
the server
acquires authentication information of the users from the image forming apparatuses;
authenticates the users according to the acquired authentication information;
performs billing in which user billing information, which is billing information in units of the authenticated users, is applied to apparatus billing information, which is billing information in units of image forming apparatuses; and
in correspondence with the performed billing, transmits billing control information for controlling functions of the image forming apparatuses.
